(19) United States
(12) Patent Application Publication
(10) Pub. No.: US 2012/0142283 A1
(43) Pub. Date: Jun. 7, 2012

(54) WIRELESS COMMUNICATION APPARATUS

(75) Inventor: Takashi TAYA, Tokyo (JP)

(73) Assignee: LAPIS SEMICONDUCTOR CO., LTD., Tokyo (JP)

(21) Appl. No.: 13/306,620

(22) Filed: Nov. 29, 2011

(30) Foreign Application Priority Data
Dec. 2, 2010 (JP) 2010-269275

(51) Int. Cl. H04B 1/40

(52) U.S. Cl. 455/76

(57) ABSTRACT

A wireless communication apparatus using a frequency signal produced by a frequency synthesizer operates at a reduced power consumption and includes a reception portion comprising a first mixer mixing a signal based on the received wireless signal and the frequency signal, a second mixer mixing the first mixer output signal and a local signal, and a demodulation stage demodulating the second mixer output signal. The frequency synthesizer comprises a Voltage Controlled Oscillator (VCO) generating a frequency signal responsive to a variation of a control input voltage, and a feed back circuit receiving as a control input voltage a voltage corresponding to a phase difference between a signal obtained by frequency dividing the output frequency signal of the VCO and a reference clock signal. The VCO is operable at a high frequency that increases with an increase of a bias current.

### BACKGROUND OF THE INVENTION

1. Field of the Invention

The present invention relates to a wireless communication apparatus using a frequency signal produced by a frequency synthesizer.

2. Description of the Related Art

Among wireless communication apparatuses used for a wireless LAN (Local Area Network) communication for example, conventionally there has been a known arrangement in which a frequency synthesizer having a PLL (Phase Locked Loop) structure is commonly used for the transmission and reception operations (see, for example, Patent Literature 1). According to the structure of this type, there is an advantage that the circuit scale can be minimized when the transmission and reception circuits are formed in an integrated circuit.

### CITATION LIST

### Patent Literature

Patent Literature 1: Japanese Patent Kokai No. 2001-119317

### SUMMARY OF THE INVENTION

Along with the recent increase in communication speed and communication amount, there is an increasing demand for reduction in electric power consumption of a radio communication apparatus that uses a frequency signal by a frequency synthesizer.

The present invention has been made in view of such a demand, and an object of the present invention is to provide a radio communications apparatus having a low electric power consumption.

A wireless communication system according to the present invention comprises; a frequency synthesizer that generates a frequency signal determined by a mode designation of one of a reception mode and a transmission mode, a transmission portion that wireless transmits a transmission signal using said frequency signal as s signal to be modulated, and a reception portion that receives a wireless signal by using said frequency signal, wherein said reception portion comprises a first mixer that mixes a signal based on a received wireless signal and said frequency signal, a second mixer that mixes an output signal of said first mixer and a local signal, and a demodulation stage that demodulates an output signal of said second mixer and produces a demodulation signal, wherein said frequency synthesizer comprises a VCO (Voltage Controlled Oscillator) that generates a frequency signal having a frequency responsive corresponding to a variation of a control input signal, and a feedback circuit that uses as said control input voltage a voltage according to a phase difference between a signal obtained by frequency dividing said frequency signal outputted from said VCO and a reference clock signal, and wherein said VCO is a variable frequency oscillator capable of operating at a frequency that increases as a bias current increases, and said bias current is controlled in accordance with said mode designation.

In the case of the wireless communication apparatus according to the present invention, electric power consumption of the apparatus can be reduces.

### BRIEF EXPLANATION OF THE DRAWINGS

FIG. 1 is a block diagram of a wireless communication apparatus that is an embodiment of the present invention;

FIG. 2 is a circuit diagram of a VCO contained in the frequency synthesizer;

FIG. 3 is a diagram showing the structure of a variable capacitance element contained in the VCO;

FIG. 4 is a diagram showing the structure of another variable capacitance element contained in the VCO;

FIG. 5 is a circuit diagram of a latch circuit as a part constituting a prescaler;

FIG. 6 is a block diagram showing the structure of the wireless communication apparatus together with frequency values during the transmission;

FIG. 7 is a block diagram showing the structure of the wireless communication apparatus together with frequency values during the reception; and

FIG. 8 is a block diagram of a wireless communication apparatus provided with a frequency divider instead of the oscillator, together with frequency values during the reception.

### DETAILED DESCRIPTION OF THE EMBODIMENTS

Hereinafter, embodiments of the present invention will be explained with reference to the accompanying drawings.

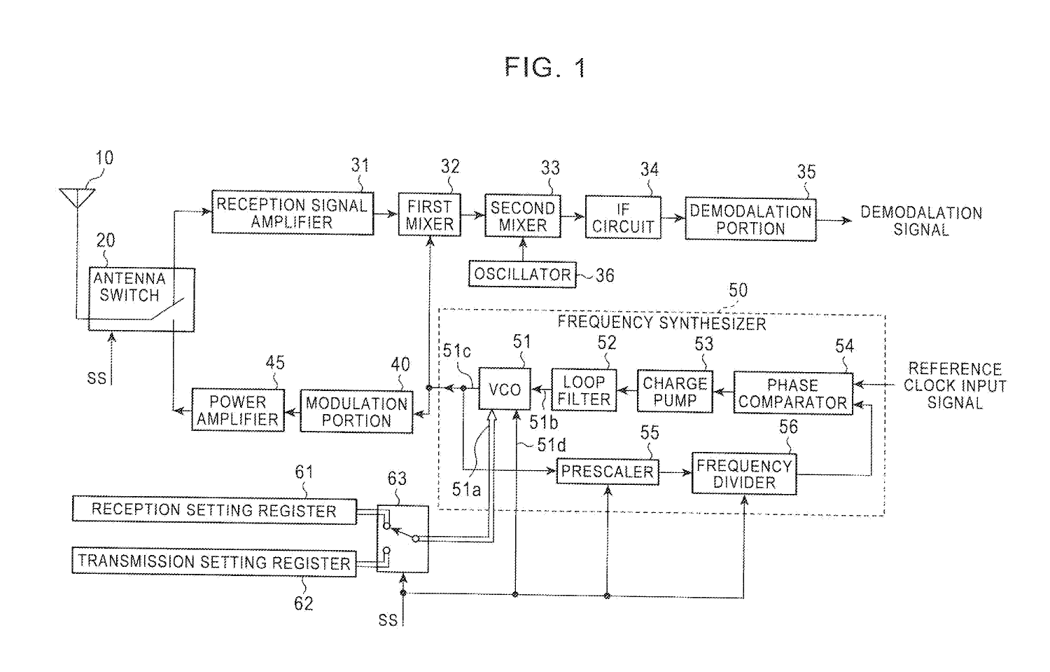

FIG. 1 is a block diagram showing the structure of a wireless communication apparatus 1 as an embodiment of the present invention. The wireless communication apparatus 1 is a wireless communication module used in a personal computer for example, when performing a wireless LAN communication.

The apparatus 1 includes an antenna 10 that is an antenna for transmitting and receiving wireless signals. An antenna switch 20 is provided for switching between the connection of function blocks 31-36 of the reception side (hereinafter, referred to as reception portion) and the antenna 10 and the connection of the function blocks 40 and 45 of the transmission side (hereinafter, referred to as transmission portion) and the antenna 10 based on a mode designation signal SS. The mode designation signal is supplied from a control circuit (not shown) in the wireless communication apparatus 1 such as a CPU, for example. As modes designatable by the mode designation signal SS there are a transmission mode and a reception mode.

A reception signal amplifier 31 receives a wireless signal arriving at the antenna 10 during a period in which the reception mode is designated by the mode designation signal SS via the antenna switch 20, amplifies the received signal, and supplies the amplified signal to a first mixer 32.

The first mixer 32 mixes the output signal of the reception signal amplifier 31 with an output signal of a frequency synthesizer 50. The first mixer 32 outputs a signal including a frequency (500 MHz, for example) of a difference between the frequency (2500 MHz, for example) of the output signal of the reception signal amplifier 31 and the frequency (2000 MHz, for example) of the output frequency signal of the frequency synthesizer 50.

A second mixer 33 mixes the output signal of the first mixer 32 and an output signal of an oscillator 36. The second mixer 33 outputs a signal including a frequency (2 MHz, for example) of a difference between the frequency (500 MHz, for example) of an input signal from the first mixer 32 and the frequency (498 MHz, for example) of an output signal of an oscillator 36.

An IF (Intermediate Frequency) circuit 34 is a circuit that performs a filtering process and a signal amplification process on the output signal of the second mixer 33. A demodulation portion 35 performs a demodulation process on a signal from the IF circuit underwent the filtering process and the like, to generate a demodulated signal.

The oscillator 36 generates a local signal (also referred to as “oscillator signal” hereinafter) having a constant frequency (498 MHz, for example).

A modulation portion 40 modulates the output frequency signal of the frequency synthesizer 50, as a signal to be modulated, by transmitting data when the transmission mode is designated by the mode designation signal SS.

A power amplifier 45 amplifies the signal modulated by the modulation portion 40. The amplified signal is transmitted as a wireless signal from the antenna 10 via the antenna switch 20.

The frequency synthesizer 50 is a phase locked loop (PLL) that is constituted by a VCO (Voltage Controlled Oscillator) 51, a loop filter 52, a charge pump 53, a phase comparator 54, a prescaler 55, and a frequency divider 56, and generates and outputs one of frequency signals (having frequencies of 2500 MHz and 2000 MHz, for example) that are different from each other, correspondingly to each of the transmission operation and the reception operation.

The VCO 51 is an oscillator that generates, as the output signal of the frequency synthesizer 50, a frequency signal having a frequency that converges to a target frequency determined in response to the mode designation signal SS, in accordance with the voltage of the input signal from the loop filter 52. A register change-over switch 63 is provided and switched between switch positions connected to a reception setting register 61 and a transmission setting register 62 respectively, and the target frequency of the frequency signal generated by the VCO 51 is changed over depending on the selective input of each of the frequency data stored in the registers 61 and 62.

The VCO 51 has a frequency designation input terminal 51a and a control voltage input terminal 51b. When frequency change data supplied to the frequency designation input terminal 51a is the data supplied from the transmission setting register 62 in response to the mode signal designating the transmission mode, the VCO 51 outputs, at an output terminal 51c, a frequency signal that varies in response to the change in the control voltage input from the loop filter 52, while targeting the high frequency (2500 MHz, for example). When the frequency change data supplied to the frequency designation input terminal 51a is the data supplied from the reception setting register 61 in response to the mode signal designating the reception mode, the VCO 51 outputs, at the output terminal 51c, a frequency signal that varies in response to the change in the control voltage input from the loop filter 52, while targeting the low frequency (2000 MHz, for example). Additionally, a bias current is controlled in response to the mode designation signal SS supplied to a bias current change-over terminal 51d.

The loop filter 52 is a filter of a feedback loop, and is a low-pass filter that outputs the input signal from the charge pump 53 after converting it to a dc (direct current) signal. The charge pump 53 raises the voltage value of the input signal from the phase comparator 54. The phase comparator 54 is a circuit that converts a phase difference between the reference clock input signal and an input signal from the frequency divider to a voltage, and outputs the converted voltage. The reference clock input signal is generated by a resonator which is not illustrated, such as a quartz resonator. The frequency of the reference clock input signal is 1 MHz for example.

The prescaler 55 is a pre-frequency divider that is provided in a stage immediately before the frequency divider 56, for frequency-dividing the frequency of the difference output circuit of the VCO 51. The frequency divider 56 frequency-divides the input signal from the prescaler 55 and supplies the divided signal to the phase comparator 54. Hereinafter, the stage comprising the prescaler 55 and the frequency divider 56 is referred to as dividing stage. The dividing ratio of the dividing stage is switched in response to the mode designation signal SS. The dividing ratio in the case that the transmission mode is designated by the mode designation signal SS is 1/2500 for example, and the dividing ratio in the case that the reception mode is designated by the mode designation signal SS is 1/2000 for example. The dividing stage is for example provided with a structure for dividing the frequency of the frequency signal of the VCO 51 at a ratio of 1/2500 and a structure for dividing the frequency of the frequency signal of the VCO 51 at a ratio of 1/2000, and the dividing radio is switched over by switching between these structures for dividing the frequency of the frequency signal of the VCO at different dividing ratios in response to the mode designation signal SS.

The prescaler 55, the frequency divider 56, the phase comparator 54, the charge pump 53, and the loop filter 52 constitute the feedback circuit that supplies, as the control voltage, to the control voltage input terminal 51b the feedback voltage corresponding to the phase difference between the frequency divided signal of the frequency signal of the VCO 51 as the output signal of the frequency synthesizer 50 and the reference clock input signal.

The reception setting register 61 stores the frequency change data to set the target frequency of the VCO 51 under the reception operation, and the transmission setting register 62 stores the frequency change data to set the target frequency of the VCO 51 under the transmission operation. The frequency change data is data for switching between the target frequencies of the frequency signal generated by the VCO 51 under the transmission operation and the reception operation.

The register change-over switch 63 performs the switching between the connection of the reception setting register 61 to the VCO 51 and the connection of the transmission setting register 62 to the VCO 51 in response to the mode designation signal SS. The register change-over switch 63 makes the connection to the transmission setting register 62 when the transmission mode is designated by the mode designation signal SS and makes the connection to the reception setting register 61 when the reception mode is designated by the mode designation signal SS. The mode designation signal SS is supplied from a control circuit in the wireless communication apparatus 1, which is not illustrated, such as a CPU.

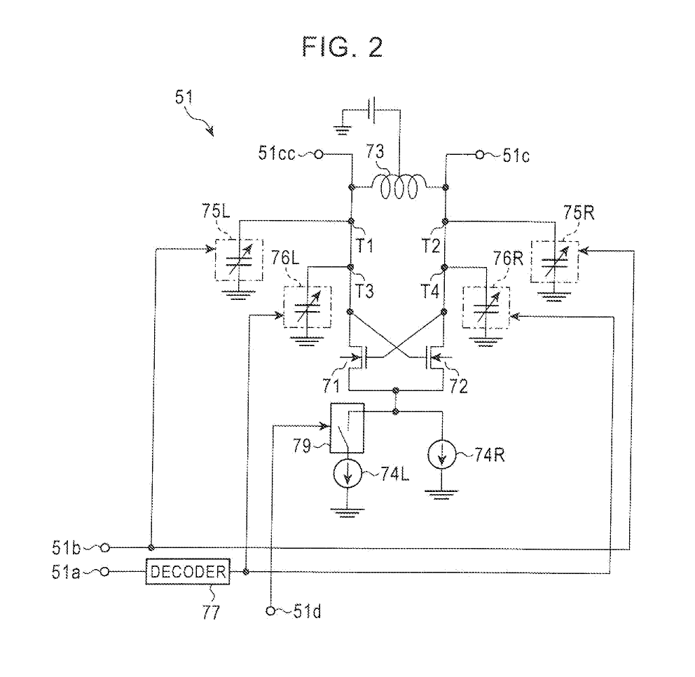

FIG. 2 shows a circuit diagram of the VCO 51. Each of transistors 71 and 72 in the VCO 51 is, for example, an nMOS (negative Metal-Oxide-Semiconductor) field effect transistor. The source of the transistor 71 is connected to one terminal of a coil 73 and the source of the transistor 72 is connected to the other terminal of the coil 73. The drain of each of the transistors 71 and 72 is directly connected to a current source 74R, and to the current source 74L via the current source switch 79. The gate of the transistor 71 is connected to the source of the transistor 72 and the gate of the transistor 72 is connected to the source of the transistor 71. The coil 73 is connected to a power potential.

A variable capacitance element 75L is connected between the one terminal of the coil 73 (node T1) and a ground potential, and a variable capacitance element 75R is connected between the other terminal of the coil 73 (node T2) and the ground potential. Capacitance values of the variable capacitance elements 75L and 75R are varied based on the control voltage from the loop filter 52 that is inputted to the control voltage input terminal 51b.

A variable capacitance element 76L is connected between the one terminal of the coil 73 (node T3) and the ground potential, and a variable capacitance element 76R is connected between the other terminal of the coil 73 (node T4) and the ground potential. Capacitance values of the variable capacitance elements 76L and 76R are varied based on the contents of the frequency change data that is inputted to the frequency designation input terminal 51a. One of the reception setting register 61 and the transmission setting register 62 is selected in response to the mode designation signal SS, and the frequency change data stored in the selected one of the registers 61 and 62 is inputted to the frequency designation input terminal 51a. The frequency change data is decoded by a decoder 77 to binary data “0101” for example, and supplied to each of the variable capacitance elements 76L and 76R.

A current source switch 79 turns on/off in response to the mode designation signal SS inputted to a bias current change-over terminal 51d. The current source switch 79 turns on when the mode designation signal SS designating the transmission mode is inputted, and turns off when the mode designation signal SS designating the reception mode is inputted.

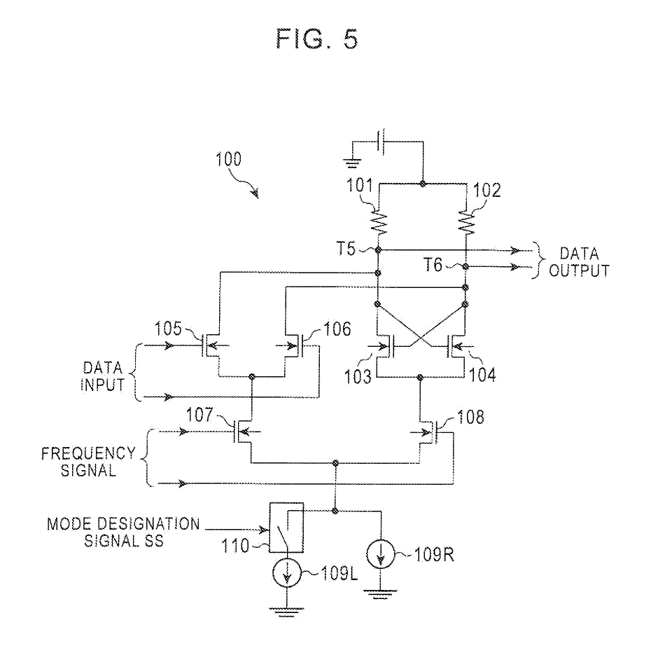

The VCO 51 having the structure described above generates the frequency signal and outputs the frequency signal at the output terminal 51c provided at the one terminal of the coil 73. The VCO 51 is a variable frequency oscillator that can operate at a frequency which increases as the bias current increases. The frequency signal at the output terminal 51c is supplied to the first mixer 32, the power amplifier 45 and the prescaler 55 (shown in FIG. 1). When the prescaler 55 having a configuration which will be explained with reference to FIG. 5 is used, the VCO 51 supplies frequency signals of positive and negative phases to the prescaler 55 via the terminal 51c and a terminal 51cc.

The bias current generated by the current source 74R and/or the current source 74L is controlled as the current source switch 79 turns on/off in response to the mode designation signal SS.

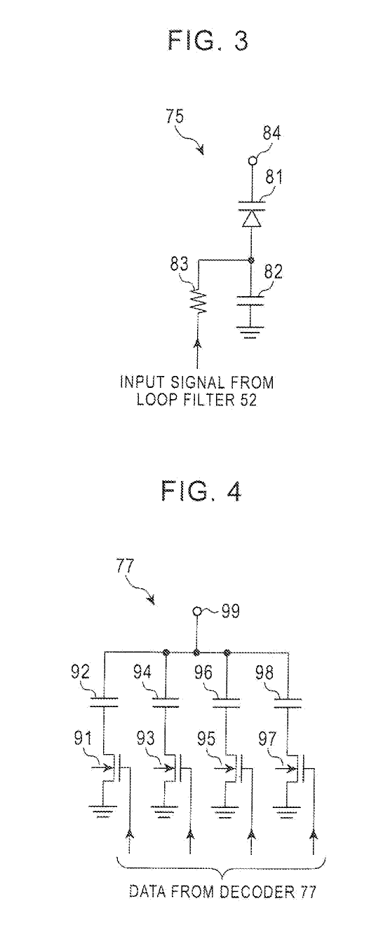

FIG. 3 shows the structure of the variable capacitance element 75L. A variable capacitance diode 81 is provided which is a so-called varactor diode having an electro-static capacitance that changes in accordance with the voltage applied across its anode and cathode. A capacitor 82 and a resistor 83 are connected to the anode terminal of the variable capacitance diode 81, and the signal from the loop filter (shown in FIG. 1) is inputted to the anode terminal 81 of the variable capacitance diode via the resistor 83. The capacitance value of the variable capacitance diode 81 decreases as the voltage value of the input signal from the loop filter 52 increases. A terminal 84 of the variable capacitance element 75L is connected to the node T1 in FIG. 2. The variable capacitance element 75R has the same structure as the variable capacitance element 75L, and the terminal 84 is connected to the node T2 in FIG. 2.

FIG. 4 shows the structure of the variable capacitance element 76L. Transistors 91, 93, 95 and 97 are provided which are nMOS field effect transistors, for example. A capacitor 92 is connected between the source of the transistor 91 and the terminal 99, a capacitor 94 is connected between the source of the transistor 93 and the terminal 99, a capacitor 96 is connected between the source of the transistor 95 and the terminal 99, and a capacitor 96 is connected between the source of the transistor 95 and the terminal 99. The drain of each of the transistors 91, 93, 95 and 97 is connected to the ground potential. One of the frequency change data stored in the reception setting register 61 and the frequency change data stored in the transmission setting register 62 is selectively inputted to each of the gates of the transistors 91, 93, 95 and 97. The terminal 99 of the variable capacitance element 76L is connected to the node T3 in FIG. 3. The variable capacitance element 76R has the same structure as the variable capacitance element 76L, and its terminal 99 is connected to the node T4 in FIG. 2.

FIG. 5 is a circuit diagram of a latch circuit 100 that constitutes a part of the prescaler 55. The structure shown in FIG. 5 is a structure in the case where the prescaler 55 receives the output frequency signal from the output terminals 51c and 51cc of the VCO 51.

Each of the resistors 101 and 102 shown in FIG. 5 is connected at one terminal thereof to the power voltage. The other terminal of the resistor 101 is connected to the source of the transistor 103. The other terminal of the resistor 102 is connected to the source of the transistor 104.

Data is output from each of terminals T5 and T6 which are provided at the source side of the transistor 103 and at the source side of the transistor 104, respectively. When the latch circuit 100 is a latch circuit at the last stage of the prescaler 55, the data outputted from the terminal T5 is outputted to the frequency divider 56 (shown in FIG. 1) as the frequency divided signal by the prescaler 55. If another latch circuit exists at a stage after the latch circuit 100, the data at each of the terminals T5 and T6 is supplied to the latch circuit at the stage after the latch circuit 100.

The gate of the transistor 103 is connected to the source of the transistor 104. The gate of the transistor 104 is connected to the source of the transistor 103. The source of the transistor 105 is connected to the source of the transistor 103. The source of the transistor 106 is connected to the source of the transistor 104. To the gates of the transistors 105 and 106, data from the non-illustrated latch in the previous stage or data from the non-illustrated latch in the last stage is supplied.

The drain of each of the transistors 105 and 106 is connected to the source of the transistor 107. The drain of each of the transistors 103 and 104 is connected to the source of the transistor 108. The frequency signal from the output terminal 51c of the VCO 51 is supplied to the gate of the transistor 107. The frequency signal from the output terminal 51cc of the VCO 51 is supplied to the gate of the transistor 108. The drain of each of the transistors 107 and 108 is directly connected to the current source 109R and also connected to the current source 109L via the current source change-over switch 110. The current sources 109R and 109L are low current sources that generate a bias current for the operation of the latch circuit 100.

The current source switch 110 turns on/off in response to the mode designation signal SS. When the mode designation signal designating the transmission mode is inputted, the current source switch 110 turns on and the current source switch 110 turns off when the mode designation signal designating the reception mode is inputted.

A plurality of the latch circuit 100 are series connected depending on the dividing ratio of the prescaler 55. For instance, when the dividing ratio is 2, two latch circuits 100 are series connected to form a D-flip flop circuit. In this case, output data from the terminals T5 and T6 of the latch circuit 100 at the front stage is inputted to the gates of the transistors 105 and 106 in the latch circuit 100 at the rear stage. Output data from the terminals T5 and T6 of the latch circuit 100 at the rear stage is sent back and inputted to the gates of the transistors 105 and 106 in the latch circuit 100 at the front stage. The frequency dividing ratio can be changed by changing the number of stages of the D-flip flop circuit in accordance with the mode designation signal SS.

Hereinafter, the operation of the wireless communication apparatus 1 will be explained. Explanation is first given on the case that the mode designation signal designating the transmission mode is supplied from a control circuit in the wireless communication apparatus 1 such as a CPU which is not illustrated in the drawings. In the following explanation, it is assumed that the wireless communication apparatus has been in the reception mode before the reception of the mode designation signal designating the transmission mode.

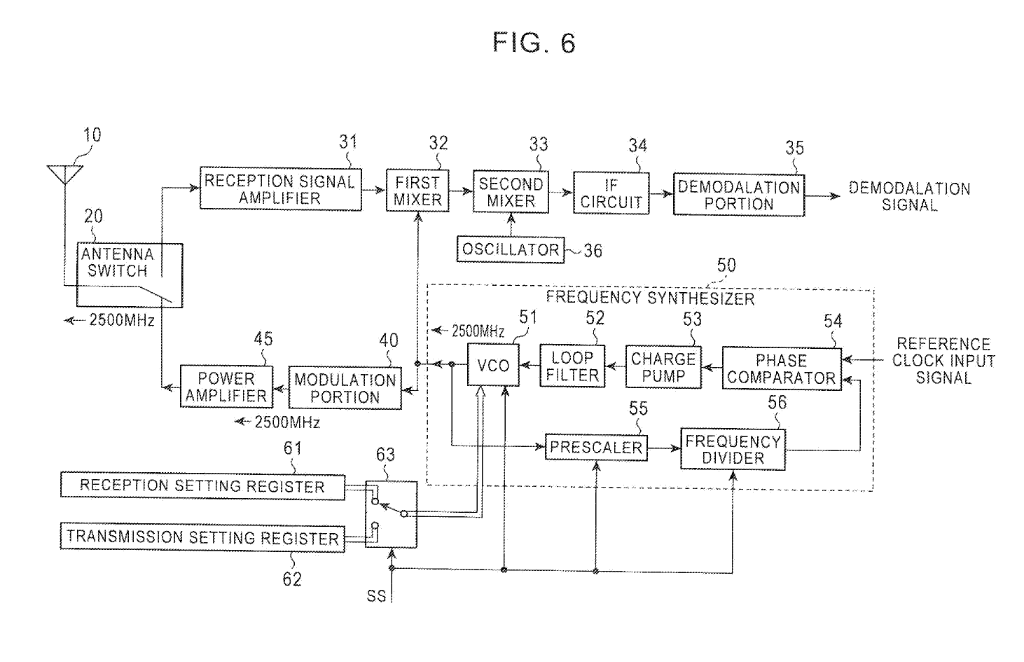

FIG. 6 is a block diagram showing the structure of the wireless communication apparatus 1 together with the frequency values at the time of transmission. In response to the mode designation signal designating the transmission mode, the antenna switch 20 switches over its switch connection to the transmission portion 40 to 45 side. In response to the mode designation signal inputted to the bias current change-over terminal 51d, the current source switch 79 of the VCO 51 (FIG. 2) turns on. The current source switch 110 of the prescaler 55 (FIG. 5) turns on in response to the mode designation signal. The dividing ratio of the prescaler 55 and the frequency divider 56 is switched over in response to the mode designation signal SS. The dividing ratio in the transmission mode is 1/2500 for example.

Furthermore, the register change-over switch 63 switches to the transmission setting register 62 side in response to the mode designation signal SS. In this state, the capacitance values of the capacitors 92, 94, 96 and 98 are, for example, 1 pF, 2 pF, 4 pF and 8 pF respectively. The capacitance value between the terminal 99 and the ground potential can be changed in a range of 1 pF to 15 pF by the on/off control of the transistors 91, 93, 95 and 97 connected in series with these capacitors 92, 94, 96 and 98.

The frequency change data stored in the transmission setting register 62 is inputted to the frequency designation input terminal 51a. The frequency change data is decoded by the decoder 77, to binary “1110”, and supplied to the variable capacitance element 76L (FIG. 2). Logical values “1”, “1”, “1”, “0” are respectively inputted to the transistors 91, 93, 95 and 97 of the variable capacitance element 76L (FIG. 4). In this case, the transistors 91, 93, and 95 turn on, and the transistor 97 turns off. As a result, the potential at the one terminals of the capacitors 92, 94, and 96 that are respectively connected in series with the transistors 91, 93, and 95 assumes the ground level. When the capacitors 92, 94 and 96 are at the on state, the capacitance value between the terminal 99 and the ground potential becomes 7 pF. That is, a capacitance of 7 pF is connected to the node T3 of the VCO 51 shown in FIG. 2. Since the variable capacitance element 76R has a similar structure, a capacitance of 7 pF is connected to the node T4 of the VCO 51 of FIG. 2. As a result of the connection of a relatively small capacitance of 7 pF across the terminals of the coil 73, the target frequency of the output frequency signal of the VCO 51 becomes relatively high.

The input signal from the loop filter 52 is respectively supplied to the variable capacitance elements 75L and 75R in FIG. 2. The circuit of the variable capacitance element 75L is shown in FIG. 3. The input signal from the loop filter 52 is supplied to the variable capacitance diode 81 via the resistor 83 (FIG. 3). When the voltage of this input signal is relatively high, the capacitance value of the variable capacitance diode 81 becomes relatively small. Conversely, when the voltage of this input signal is relatively low, the capacitance value of the variable capacitance diode 81 becomes relatively large. The voltage value of the input signal from the loop filter 52 varies, for example, in a range of 0.5 V to 1.5 V, and the capacitance value of the variable capacitance diode 81 varies in a range of 1 pF to 3 pF. By the structure described above, the variable capacitance value connected between the terminal 84 (node T1 in FIG. 2) and the ground potential is minutely adjusted between 1 pF and 3 pF. Since the variable capacitance element 75R is constructed similarly, the variable capacitance value connected between the node T2 of the VCO 51 in FIG. 2 and the ground potential is also minutely adjusted.

In this way, the variable capacitance elements 75L and 75R are configured to vary the capacitance value, for example, in the range of 1 pF to 15 pF so that the target frequency of the frequency signal of the VCO 51 is adjusted in a relatively wide range, and in contrast the variable capacitance elements 76L and 76R are configured to vary the capacitance value, for example, in the range of 1 pF to 3 pF so that the target frequency of the frequency signal of the VCO 51 is minutely adjusted. By the setting described above, the target frequency of the output frequency signal of the frequency synthesizer 50 is adjusted to the relatively high value (2500 MHz, for example) and the output frequency signal of the frequency synthesizer 50 is minutely adjusted in accordance with the input signal from the loop filter 52 during the transmission.

The current source switch 79 included in the VCO 51 (FIG. 2) turns on in response to the mode designation signal SS, and the current source 74L is connected. Furthermore, the current source change-over switch 110 included in the latch circuit 100 (FIG. 5) constituting the prescaler 55 turns on in response to the mode designation signal SS, and the current source 109L is connected. As described above, the oscillation frequency of the VCO 51 during the transmission becomes relatively high by the variable capacitance elements 75L to 76R. The higher the frequency of the frequency signal, the higher electric consumption is needed, and accordingly the current sources 74L and 109L are connected so that the supply current becomes relatively large.

The output frequency signal of the frequency synthesizer 50 is modulated by the modulation portion 40, and in turn supplied to the power amplifier 45. The power amplifier 45 amplifies the modulated signal and performs the wireless transmission of the amplified signal through the antenna 10 via the antenna switch 20.

The operation of the wireless communication apparatus 1 will be further explained on the case that the mode designation signal SS designating the reception mode is supplied from the control circuit in the wireless communication apparatus 1 such as the CPU which is not illustrated in the drawings.

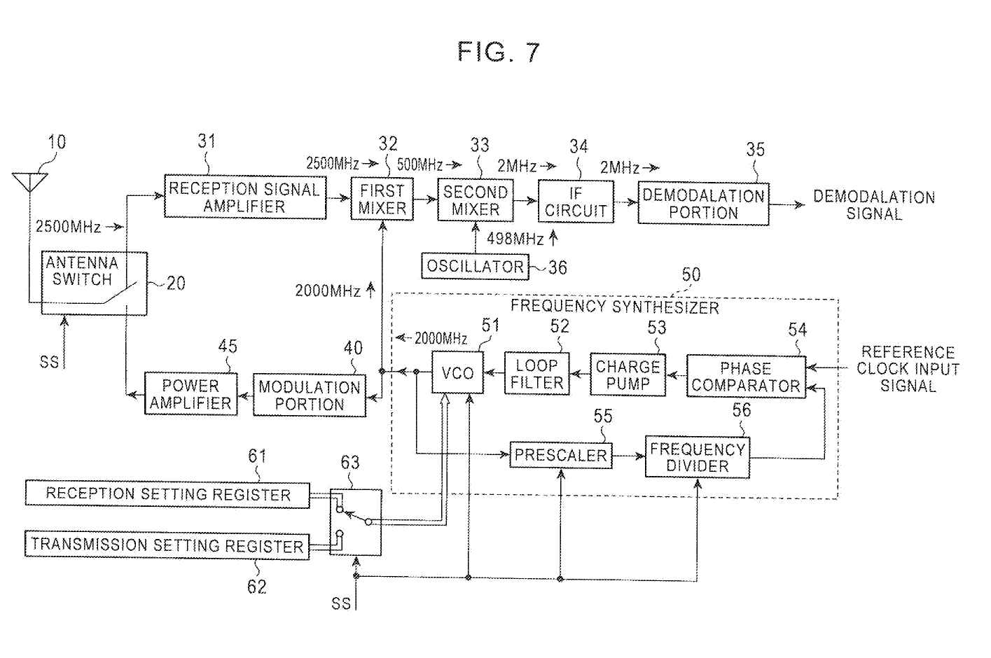

FIG. 7 is a block diagram showing the structure of the wireless communication apparatus 1 together with the frequency at the time of reception. In response to the mode designation signal designating the reception mode, the antenna switch 20 switches over its switch connection to the reception portion 31 to 36 side. In response to the mode designation signal inputted to the bias current change-over terminal 51d, the current source switch 79 of the VCO 51 (FIG. 2) turns off. The current source switch 100 of the prescaler 55 (FIG. 5) turns off in response to the mode designation signal. The dividing ratio of the prescaler 55 and the frequency divider 56 is switched over in response to the mode designation signal SS. The dividing ratio in the reception mode is 1/2000 for example. The register change-over switch 63 switches to the reception setting register 61 side in response to the mode designation signal SS.

The frequency change data stored in the reception setting register 61 is inputted to the frequency designation input terminal 51a. The frequency change data is decoded, by the decoder 77, to binary “0111”, and supplied to the variable capacitance element 76L (FIG. 2). Logical values “0”, “0”, “0”, “1” are respectively inputted to the transistors 91, 93, 95 and 97 of the variable capacitance element 76L (FIG. 4). In this case, the transistors 91, 93, and 95 turn off, and the transistor 97 turns on. As a result, the potential at the one terminals of the capacitors 94, 96, and 98 that are respectively connected in series with the transistors 91, 93, and 95 assumes the ground level. When the capacitance values of the capacitors 94, 96 and 98 are 2 pF, 4 pF and 8 pF respectively, the capacitance value between the terminal 99 and the ground potential becomes 14 pF. That is, a capacitance of 14 pF is connected to the node T3 of the VCO 51 shown in FIG. 2. Since the variable capacitance element 76R (FIG. 2) has the similar structure, a capacitance of 14 pF is connected to the node T4 of the VCO 51 of FIG. 2. Thus the target frequency of the output frequency signal of the VCO 51 becomes lower than that during the transmission because the capacitance value (14 pF for example) larger than the capacitance value during the transmission (7 pF in the example described above) is connected across the terminals of the coil 73.

The input signal from the loop filter 52 is supplied to the variable capacitance elements 75L and 75R in FIG. 2. The circuit of the variable capacitance element 75L is shown in FIG. 3 and the variable capacitance element 75L operates in the same manner as the transmission time. The voltage value of the input signal of the loop filter 52 varies in the range of 0.5 V to 1.5 V for example, and the capacitance value of the variable capacitance diode 81 varies in the range of 1 pF to 3 pF.

The variable capacitance value connected between the terminal 84 (the node T1 in FIG. 2) and the ground potential is minutely adjusted in accordance with the input signal of the loop filter 52. Since the variable capacitance element 75R is constructed similarly, the variable capacitance value connected between the node T2 of the VCO 51 in FIG. 2 and the ground potential is also minutely adjusted.

By the above described setting, the target frequency of the output frequency signal of the frequency synthesizer 50 is adjusted to the relatively low value (2000 MHz, for example) and the output frequency signal of the frequency synthesizer 50 is minutely adjusted in accordance with the input signal from the loop filter 52 during the reception.

The current source switch 79 included in the VCO 51 (FIG. 2) turns off in response to the mode designation signal SS, and the current source 74L is disconnected. Furthermore, the current source change-over switch 110 included in the latch circuit 100 (FIG. 5) constituting the prescaler 55 turns off in response to the mode designation signal SS, and the current source 109L is disconnected. As described above, the target frequency of the frequency signal of the VCO 51 during the transmission becomes relatively low by the variable capacitance elements 75L to 76R. The lower the frequency of the frequency signal, the smaller electric consumption is realized, and accordingly the current sources 74L and 109L are disconnected so that the power consumption during the reception is reduced as compared with the power consumption during the transmission.

The wireless reception signal received by the antenna 10 is supplied to the reception signal amplifier 31 via the antenna switch 20. The frequency of the wireless reception signal is 2500 MHz, for example. The wireless reception signal amplified by the reception signal amplifier 31 (hereinafter, referred to as amplified reception signal) is supplied to the first mixer 32. The output frequency signal of the frequency synthesizer 50 is also supplied to the first mixer 32. The frequency of the output frequency signal is, for example, 2000 MHz.

The first mixer 32 mixes the amplified reception signal from the reception signal amplifier 31 and the output frequency signal of the frequency synthesizer 50, and outputs a signal including the frequency component of 500 MHz which is the difference between the frequencies of these signals.

The output signal of the first mixer 32 is supplied to the second mixer 33. The output signal of the oscillator 36 is also supplied to the second mixer 33. The frequency of this output signal is 498 MHz, for example. The second mixer 33 mixes the output signal of the first mixer 32 and the output signal of the oscillator 36, and outputs the signal including the frequency component of 2 MHz which is the difference between the frequencies of these signals.

The IF circuit 34 performs the filtering process and the signal amplification process on the output signal of the second mixer 33. The demodulation portion 35 performs the demodulation process on the signal obtained by the filtering process and the like at the IF circuit 34, and outputs the demodulation signal.

Thus, the wireless communication apparatus 1 of this embodiment has two mixers, namely, first mixer 32 and the second mixer 33, and stepwisely reduces the frequency (2500 MHz, for example) of the wireless signal received by the antenna 10, and produces the demodulation signal of a desired frequency (2 MHz, for example). By the provision of the mixer at the rear stage, namely the second mixer 33 which reduces the frequency based on the output signal of the oscillator 36, it is made possible to significantly reduce the frequency (2000 MHz, for example) of the output signal of the frequency synthesizer 50 supplied to the mixer in the front stage, namely the first mixer 32, during the reception operation.

If we assume that the signal of the desired frequency 2 MHz is to be generated from the frequency 2500 MHz of the wireless signal in a configuration provided with the first mixer 32 only unlike the embodiment described above, it is necessary to set the frequency of the output frequency signal of the frequency synthesizer at 2498 MHz during the reception operation. Therefore, a case, it is not possible to reduce the frequency of the output frequency signal in such a case. It is assumed that the power consumption of the frequency synthesizer increases as its frequency increases. Thus, in the case of the conventional wireless communication apparatuses that use the substantially same frequency in both of the transmission and reception operations, the electric power consumption during the transmission and the electric power consumption during the reception become substantially the same. In contrast, the wireless communication apparatus 1 of this embodiment uses two mixers, and the frequency of the output signal of the frequency synthesizer 50 can be significantly reduced.

Additionally, the wireless communication apparatus 1 of this embodiment includes the variable capacitance elements 75L to 76R in the VCO 51. The electric power consumption of the frequency synthesizer 50 is reduced by the selective input of the frequency change data held by each of the reception setting register 61 and the transmission setting register 62, the target frequency of the frequency signal of the VCO 51 during the reception is made lower than the target frequency during the transmission, and further by disconnecting the current source 74 during the reception in response to the mode designating signal designating the reception mode. Furthermore, the electric power consumption of the frequency synthesizer 50 is reduced also by disconnecting the current source 109L during the reception with respect to the current source 109L of the latch circuit 100 which constitutes the prescaler 55. In this way, the target frequency of the output frequency signal of the frequency synthesizer 50 is lowered during the reception, and the electric power consumption is reduced in association with the decrease of the target frequency.

Generally, the duration of the reception operation is longer than the duration of the transmission operation in the wireless communication apparatus. Therefore, the electric power consumption as a whole of the frequency synthesizer 50 can be reduced in an efficient manner by the reduction of the electric power consumption of the frequency synthesizer 50 during the reception operation in the wireless communication apparatus of this embodiment.

Furthermore, generally the electric power consumption of portions used during the reception such as the demodulator is relatively large as compared with the electric power consumption during the transmission in the case of short distance wireless communication apparatuses that operate with a small battery cell like a button cell battery. In the case of the wireless communication apparatus 1 of this embodiment, it is considered that the amount of the voltage drop during the reception is reduced because the electric power consumption of the frequency synthesizer 50 during the reception is reduced. Therefore, an advantageous effect is obtained that a malfunction of the apparatus due to an excessive voltage drop amount can be avoided even if the battery cell used in the wireless communication apparatus is downsized.

### Modified Embodiment

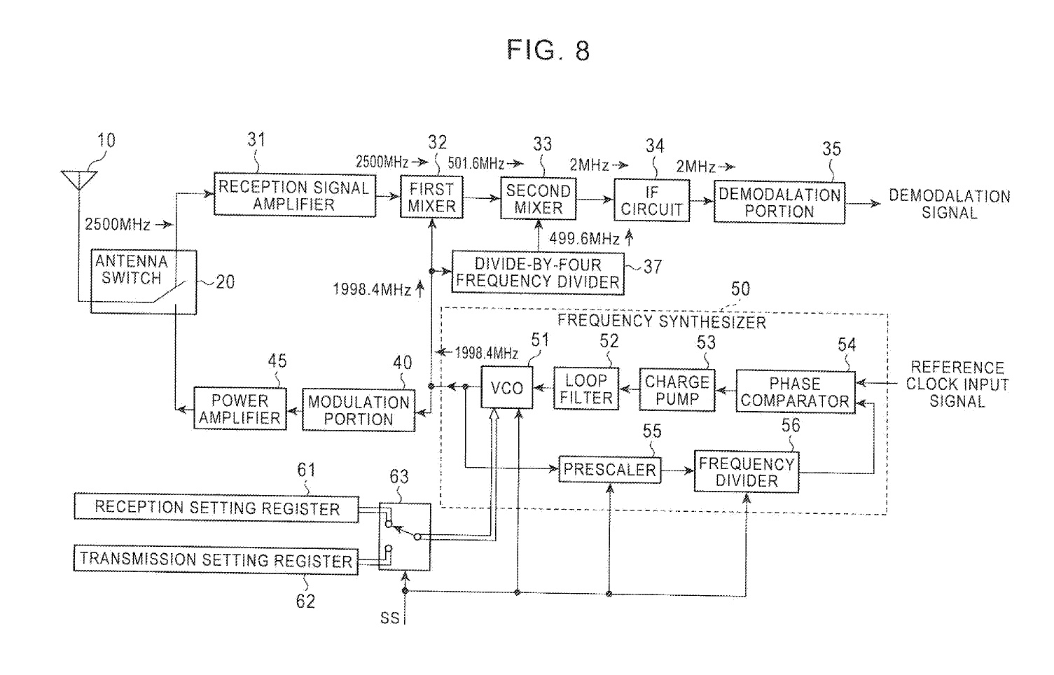

FIG. 8 is a block diagram showing the configuration of the wireless communication apparatus 1 provided with a divide-by-four frequency divider 37 in place of the oscillator 36 together with frequency values during the reception.

In this configuration, the frequency of the output signal of the frequency synthesizer 50 is set to 1998.4 MHz, for example, by adjusting the dividing ratios of the prescaler 55 and the frequency divider 56, the frequency change data of the reception setting register 61, and the capacitance values of the capacitor 92, 94, 96 and 98 of the variable capacitance element 76L (FIG. 2).

The first mixer 32 mixes the amplified reception signal from the reception signal amplifier 31 and the output frequency signal of the frequency synthesizer 50, and outputs a signal including the frequency component of 501.6 MHz which is the difference between the frequencies of these signals.

The divide-by-four frequency divider 37 outputs a frequency divided signal of 499.6 MHz which is a quarter of the frequency 1998.4 MHz of the output signal of the frequency synthesizer 50.

The second mixer 33 mixes the output signal of the first mixer 32 and the output signal of the divide-by-four frequency divider 37, and outputs the signal including the frequency component of 2 MHz which is the difference between the frequencies of these signals.

The IF circuit 34 performs the filtering process and the like on the output signal of the second mixer 33. The demodulation portion 35 performs the demodulation process on the signal obtained by the filtering process and the like, and outputs the demodulation signal.

Thus, the signal supplied to the second mixer 33 is generated by the divide-by-four frequency divider 37, so that demodulation signal of the desired frequency of, for example, 2 MHz can be produced without the provision of the oscillator 36.

This application is based on Japanese Patent Application 2010-269275 which is herein incorporated by reference.

What is claimed is:

1. A wireless communication apparatus comprising:
a frequency synthesizer that generates a frequency signal determined by a mode designation of one of a reception mode and a transmission mode;
a transmission portion that wireless transmits a transmission signal using said frequency signal as a signal to be modulated; and
a reception portion that receives a wireless signal using said frequency signal, wherein said reception portion comprises:
a first mixer that mixes a signal based on a received wireless signal and said frequency signal;
a second mixer that mixes an output signal of said first mixer and a local signal; and
a demodulation stage that demodulates an output signal of said second mixer and produces a demodulation signal, wherein said frequency synthesizer comprises:
a voltage controlled oscillator that generates a frequency signal having a frequency corresponding to a variation of a control input voltage; and
a feedback circuit that uses as said control input voltage a voltage according to a phase difference between a signal obtained by frequency dividing said frequency signal outputted from said voltage controlled oscillator and a reference clock signal, and wherein said voltage controlled oscillator is a variable frequency oscillator capable of operating at a high frequency which increases as a bias current increases, and said bias current is controlled in accordance with said mode designation.

2. A wireless communication apparatus as claimed in claim 1, wherein said feedback circuit includes a frequency dividing stage having a frequency dividing ratio that changes according to said mode designation.

3. A wireless communication apparatus as claimed in claim 2, wherein said frequency dividing stage comprises:
a prescaler that performs a frequency dividing operation at a frequency dividing ratio determined by said mode designation;
and
a frequency divider that frequency divides a frequency divided output signal of said prescaler at a frequency dividing ratio determined by said mode designation.

4. A wireless communication apparatus as claimed in claim 1, further comprising a setting data holding portion that holds high frequency setting data and low frequency setting data,
wherein said setting data holding portion selectively supplies either one of said high frequency setting data and low frequency setting data to said voltage controlled oscillator, and
wherein said voltage controlled oscillator generates the frequency signal of a high frequency or a low frequency according to a content of said setting data.

5. A wireless communication apparatus as claimed in claim 2, further comprising a setting data holding portion that holds high frequency setting data and low frequency setting data,
wherein said setting data holding portion selectively supplies either one of said high frequency setting data and low frequency setting data to said voltage controlled oscillator, and
wherein said voltage controlled oscillator generates the frequency signal of a high frequency or a low frequency according to a content of said setting data.

6. A wireless communication apparatus as claimed in claim 3, further comprising a setting data holding portion that holds high frequency setting data and low frequency setting data,
wherein said setting data holding portion selectively supplies either one of said high frequency setting data and low frequency setting data to said voltage controlled oscillator, and
wherein said voltage controlled oscillator generates the frequency signal of a high frequency or a low frequency according to a content of said setting data.

7. A wireless communication apparatus as claimed in claim 3, wherein a bias current supplied to a latch circuit constituting said prescaler is controlled in accordance with said mode designation.

8. A wireless communication apparatus as claimed in claim 1, wherein said local signal is an oscillation signal generated by an oscillator.

9. A wireless communication apparatus as claimed in claim 1, wherein said local signal is a frequency divided signal obtained by frequency dividing said frequency signal.
